(19) United States
(12) Patent Application Publication
(10) Pub. No.: US 2005/0006130 A1
(43) Pub. Date: Jan. 13, 2005

(54) Reflective surge suppressing cable

(75) Inventors: Masami Kimijima, Minamitsuru-gun (JP); Yuuichi Yamada, Minamitsuru-gun (JP); Masanobu Nakamura, Tokyo (JP); Takashi Tamura, Suwa-gun (JP); Tomoo Miyazaki, Isesaki-shi (JP)

Correspondence Address: STAAS & HALSEY LLP, SUITE 700, 1201 NEW YORK AVENUE, N.W., WASHINGTON, DC, 20005, US

(73) Assignees: FANUC LTD, Yamanashi (JP); OKI ELECTRIC CABLE CO., LTD., Kawasaki (JP)

(21) Appl. No.: 10/886,697

(22) Filed: Jul. 9, 2004

(30) Foreign Application Priority Data
Jul. 10, 2003 (JP) 272727/2003

(51) Int. Cl. H01B 7/18

(52) U.S. Cl. 174/108

(57) ABSTRACT

A reflective surge suppressing cable is provided wherein surge is suppressed by canceling a specific frequency component of the surge by reflection. A main wire is constituted by an insulated core wire comprising a conductor covered with for plating for increasing resistance, and provided thereon with an insulator of high permittivity. An auxiliary wire is constituted by an insulating core provided with shielding on top of a construction identical with that of the main wire. The reflection is deliberately generated by adjusting the length of the auxiliary wire when winding the auxiliary wire in the longitudinal direction around the periphery of the main wire.

### BACKGROUND OF THE INVENTION

1. Field of the Invention

The present invention is employed in surge suppressing. cables of high impedance load systems typified by drive circuits, transmission cables or motors and relates to a reflective surge suppressing cable of excellent economy, ease of use, that offers excellent productivity and practicability and is applicable to a wide range of uses by reducing deterioration of transmission quality and, in addition, reducing the shortening of life that is caused by deterioration of insulation of the cable and connecting equipment thereof and generation of noise due to surges, by suppressing, within the cable itself, surges (unwanted high-voltage waveforms produced by mismatched reflection) generated by impedance mismatching.

2. Description of the Related Art

Conventionally, generation of surges can be suppressed by matching the characteristic impedance of the cable with the impedance of the output system and load. However, there are manifold variations of the impedance of the load, and, depending on the equipment used and on the system, surges or ringing (oscillation generated by for example stray capacitance, residual impedance or reflection, during operation or recovery in a switching circuit) may be generated due to difference of impedance or frequency dependence of the matching component or cable even though impedance matching is sought. Such surges or ringing causes severe deterioration of signal quality. Such circumstances cause similar problems not only in the transmission system but also in the drive system as the speed of operation is increased. In particular, if the load is a motor, manufacturing a matched cable is extremely difficult, since the motor presents impedance (at least 500 Ω) considerable large as compared with the case of an ordinary transmission system. The methods that are currently employed involve insertion of a filter using C and L, suppressing the surge level by slowing down the rise time of the output circuit, and employing a cable with a length in a range in which the effect of surge level is small. However, the methods of slowing down the rise time of the output circuit or restricting the length of the cable used do not meet the needs of the market. Also, use of filtering requires additional components and, in particular in cases where the load system requires large power, providing the necessary installation space presents a serious problem. In order to solve the above technical problems, a surge suppressing high-speed metallic cable has been proposed (Japanese Patent Application Laid-open No. 2003-346571, laid-open on Dec. 5, 2003) which employs a 3-core construction of three independently shielded respectively insulated wires, together with a wire employed as a GND conductor, with whole of the wires twisted together and sheathed, but even with this cable, sufficient surge suppression is not achieved.

### SUMMARY OF THE INVENTION

A problem to be solved by the present invention is to provide a reflective surge suppressing cable wherein the deterioration in the life of the system resulting from for example insulation deterioration of the motor caused by unwanted surges can be suppressed and wherein a reduction of radiation produced by noise generated by surges can be achieved and which is of excellent economy, ease of use, productivity and practicability.

According to a first embodiment of the present invention, there is provided a reflective surge suppressing cable wherein an auxiliary wire in which shielding is provided on an insulated core wire constituted by applying an insulator onto a conductor is wound in the longitudinal direction around the periphery of a main wire comprising an insulated core wire constituted by applying an insulator onto a conductor, or the auxiliary wire is separated with respect to the main wire by extracting to the outside.

According to a second embodiment of the present invention, there is provided a reflective surge suppressing cable wherein, in the first embodiment, surges are suppressed by canceling specified frequency components of a surge by reflection, by deliberately generating reflection by adjusting the length of an auxiliary wire when winding the auxiliary wire on in the longitudinal direction or when separating the auxiliary wire by extracting to the outside.

According to a third embodiment of the present invention, there is provided a reflective surge suppressing cable wherein the conductor of the main wire or auxiliary wire according to the first or second embodiment is covered with an electrically conductive material or plating in order to further promote reduction of high-band noise and increase resistance and/or inductance.

According to a fourth embodiment of the present invention, there is provided a reflective surge suppressing cable wherein, in order to further promote reduction of high-band noise, an insulator of high permittivity and/or high dielectric loss is employed as an insulator of the main wire or auxiliary wire according to the first or second embodiment.

A fifth embodiment of the present invention consists in a construction combining the first, second, third and fourth embodiment.

By employing a reflective surge suppressing cable according to the present invention with a high impedance load typified by a motor load, which must be controlled at high speed, unwanted surges can be eliminated and, in addition, a reduction in noise radiation produced by surges can be achieved and a cable obtained which is of excellent economy and ease of use and offers excellent productivity and practicability and excellent space-saving characteristics, and which is applicable to a wide range of uses.

### BRIEF DESCRIPTION OF THE DRAWINGS

FIG. 1A is a cross-sectional view of a typical embodiment of a reflective surge suppressing cable according to the present invention;

FIG. 1B is a side view of the reflective surge suppressing cable shown in FIG. 1A;

FIG. 2 is a diagram showing the principles of surge suppression by utilizing the reflection effect, and the connection condition, in respect of a reflective surge suppressing cable according to the present invention;

FIG. 3 is a view illustrating the relationship between length of the main wire and auxiliary wire and reflection frequency, in respect of a reflective surge suppressing cable according to the present invention;

FIG. 4 is a view showing the results of comparison of the surge waveforms of a reflective surge suppressing cable according to the present invention and a conventional cable, at a cable length of 10 m; and

FIG. 5 is a view showing the results of comparison of the surge waveforms of a reflective surge suppressing cable according to the present invention and a conventional cable, at a cable length of 40 m.

### DESCRIPTION OF THE PREFERRED EMBODIMENTS

Embodiments of a reflective surge suppressing cable 1 according to the present invention are described in detail below with reference to the appended drawings.

First of all, a first embodiment will be described. This consists in a reflective surge suppressing cable construction wherein, although not shown in the drawings, an auxiliary wire in which shielding is provided on an insulated core wire constituted by applying an insulator onto a conductor is wound in the longitudinal direction around the periphery of a main wire comprising an insulated core wire constituted by applying an insulator onto a conductor. Alternatively, instead of combining the foregoing as a single cable, a separated construction may be adopted, in which the auxiliary wire is extracted to the outside with respect to the main wire. Copper wire containing for example zinc may be used as a typical example of a conductor. PE, PVC or PVDF may be used as typical examples of insulators.

As a second embodiment, in the first embodiment, a construction is adopted in which surges are suppressed by canceling a specified frequency component of a surge by reflection, by deliberately generating reflection by adjusting the length of an auxiliary wire when winding the auxiliary wire on in the longitudinal direction or when separating the auxiliary wire by extracting to the outside.

As a third embodiment, a construction is adopted in which the conductors of the main wire and auxiliary wire according to the first or second embodiment are covered with an electrically conductive material or plating in order to further promote reduction of high-band noise and to increase resistance and/or inductance. A material of large complex permeability such as Ni plating, of larger conductor resistance than copper, may be used as a typical example of a conductive material or plating material.

As a fourth embodiment, a construction is adopted in which, in order to promote reduction of high-band noise, an insulator of high permittivity and/or high dielectric loss is employed as an insulator of the main wire or auxiliary wire according to the first or second embodiment. Vinylidene fluoride may be used as a typical example of an insulator combining high permittivity and high dielectric loss.

A fifth embodiment consists in a construction combining the first, second, third and fourth embodiments.

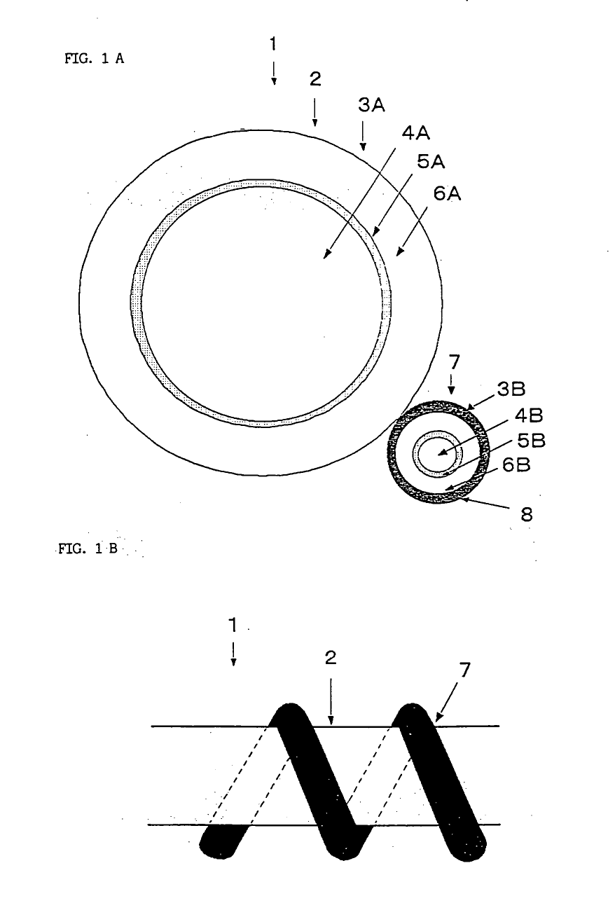

Typical embodiments of the above are described with reference to the drawings. FIG. 1A is a cross-sectional view of a typical embodiment of a reflective surge suppressing cable 1 according to the present invention; FIG. 1B is a side view of the reflective surge suppressing cable 1 shown in FIG. 1A.

As is clear from FIG. 1A and FIG. 1B, in a reflective surge suppressing cable 1 according to this embodiment, an auxiliary wire 7 is wound in the axial direction of the main wire 2 about the periphery of the main wire 2. The main wire 2 comprises an insulated core wire 3A which is composed of a conductor 4A, an electrically conductive material or plating 5A covering the conductor 4A for increasing the resistance and/or the inductance of the conductor 4A, and a high permittivity insulator and/or high dielectric loss insulator 6A provided on the electrically conductive material or plating 5A. The auxiliary wire 7 comprises an insulated core wire 3B which is composed of a conductor 4B, an electrically conductive material or plating 5B covering the conductor 4B for increasing the resistance and/or inductance of the conductor 4B, and a high permittivity insulator and/or high dielectric loss insulator 6B provided on the electrically conductive material or plating 5B.

When winding this auxiliary wire 7 around the main wire 2, the length of this auxiliary wire 7 is adjusted, with the result that reflection is deliberately generated, making it possible to cancel a specific frequency component of the surge by the reflection that is produced, thereby enabling the surge to be suppressed. Consequently, according to the present invention, a reflective surge suppressing cable can be provided that is capable of high-band use.

The cable construction according to the present invention can be applied to all ordinary cables, such as single core, double core, coaxial, flat cables and twisted pair cables.

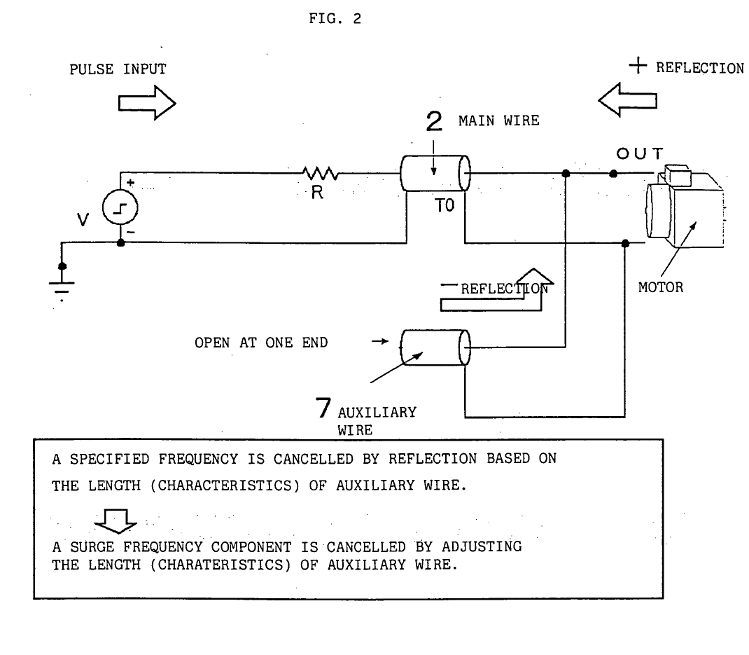

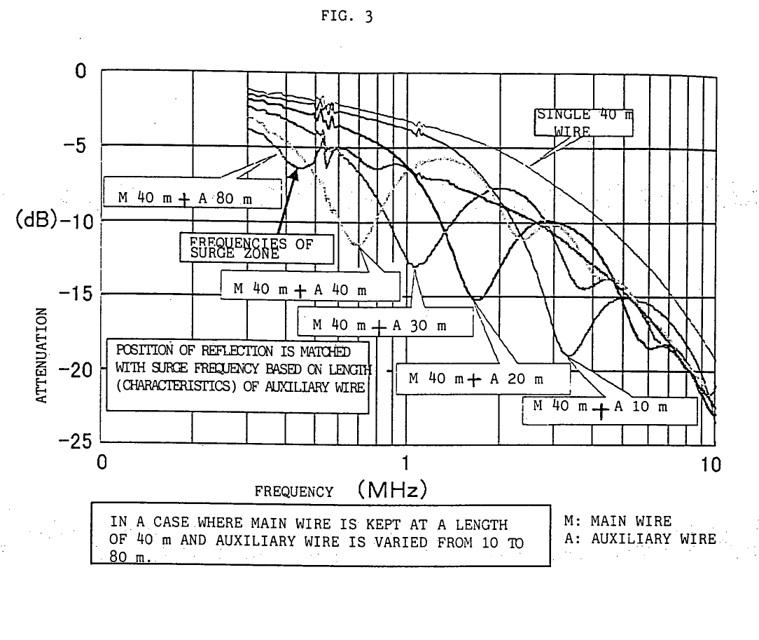

FIG. 2 is a diagram showing the principles of surge suppression using the reflection effect and connection condition of a reflective surge suppressing cable 1 according to the present invention constructed as above. As can be seen from this Figure, the conductors of the main wire and the auxiliary wire are connected. Reflection is deliberately generated by means of this connection condition and a specified frequency, depending on the length (characteristics) of the auxiliary wire, is cancelled by the reflection. Specifically, surges can be suppressed by canceling of frequency components by adjusting the length (characteristics) of the auxiliary wire. Next, FIG. 3 is a view given in explanation of the relationship between length of the main wire 2 and auxiliary wire 7 and reflection frequency, in respect of a reflective surge suppressing cable 1 according to the present invention.

This embodiment is an example of the case in which the main wire 2 is always of length 40 m and the auxiliary wire 7 is varied from 10 to 80 m. It can be seen from the Figure that the position of reflection can be matched with the surge frequency based on the length (characteristics) of the auxiliary wire.

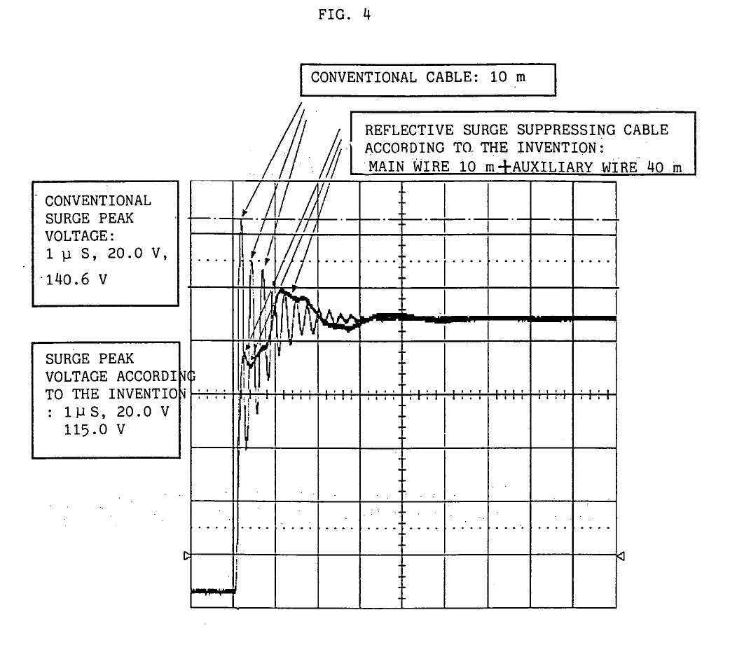

Next, FIG. 4 shows the results of a comparison of surge waveforms of a reflective surge suppressing cable according to the present invention and a conventional cable, at a cable length of 10 m.

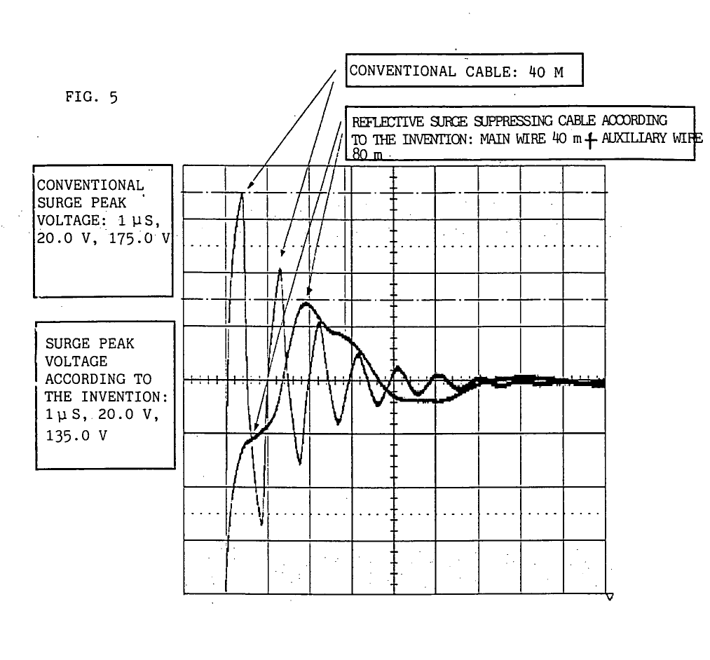

From this Figure, it can be seen that, whereas, with a conventional cable, motor loading has a considerable effect on reflection, with the cable according to the present invention, the effect of motor loading on reflection does not appear, due to the high-band filtering action that takes place in the cable itself. Finally, FIG. 5 shows the results of comparison of the surge waveforms of a reflective surge suppressing cable according to the present invention and a conventional cable, at a cable length of 40 m.

From this Figure, it can be seen that the same excellent results are obtained when the cable length is 40 m as in the case where the cable length is 10 m.

Although in the embodiments of the present invention, the case of a single insulated core wire is described as a representative example, there is no restriction to this number of insulated core wires. Also, although, PE is used as a typical example as an insulating material, mesh shielding is used as a typical example of shielding, and vinylidene fluoride is used as a typical example of an insulating material having a high permittivity and also high dielectric loss, in the embodiments of the present invention, there is no restriction to these. Furthermore, although Ni is used as a suitable material in the case of plating of the signal conductor, there is no restriction to this. Also, although, in the above description, the main wire and the auxiliary wire are of the same construction apart from the shielding 8, they need not necessarily be of the same construction and could be somewhat modified. Furthermore, although it is preferable that the auxiliary wire should be provided with shielding on its outside, an auxiliary wire provided with no shielding may be used. Thus the present invention of course may include various modifications.

The present invention may be applied to surge suppressing cables of high impedance load systems typified by drive circuits, transmission cables and motors; as surges produced by impedance mismatching are suppressed in the cable itself, improvement can be achieved in respect of deterioration of transmission quality and, in addition, amelioration of the adverse effect on life produced by the insulation deterioration of cables and connecting equipment etc. and diminution of noise generation caused by surges can be achieved. Thus, the present invention offers excellent economy, ease of use, productivity and practicability and has a wide range of application.

1. A reflective surge suppressing cable comprising a construction in which a main wire and an auxiliary wire are combined in separated or integrated fashion, wherein
said main wire is constituted by an insulated core wire having an insulator applied onto a conductor or by an insulated shielded core wire having shielding provided on top of said insulated core wire, and
said auxiliary wire is constituted by an insulated core wire having an insulator applied onto a conductor or by further providing shielding on top of said insulated core wire.

2. A reflective surge suppressing cable having an auxiliary wire wound around the periphery of a main wire in the longitudinal direction of the main wire, wherein
said main wire is constituted by an insulated core wire having an insulator applied onto a conductor or an insulated shielded core wire having shielding provided on top of said insulated core wire, and
said auxiliary wire is constituted by an insulated core wire having an insulator applied onto a conductor or by further providing shielding on top of said insulated core wire.

3. The reflective surge suppressing cable according to claim 1, wherein reflection is deliberately generated by adjusting the length of the auxiliary wire when creating the construction in which the main wire and auxiliary wire are combined in separated or integrated fashion or when winding the auxiliary wire around the periphery of the main wire in the longitudinal direction of this main wire, so that surge is suppressed by canceling a specific frequency component of the surge by the reflection thus generated.

4. The reflective surge suppressing cable according to claim 1, wherein, in the main wire and auxiliary wire, the conductor is covered with a conductive material or plating in order to further promote reduction of high-band noise and to increase resistance and/or inductance.

5. The reflective surge suppressing cable according to claim 1, wherein, in the main wire and auxiliary wire, in order to promote reduction of high-band noise, an insulator of high permittivity and/or an insulator of high dielectric loss are/is employed as the insulator.

6. A reflective surge suppressing cable consisting of a combination of claim 1, claim 4 and claim 5, further provided with shielding on top of said combination.

7. The reflective surge suppressing cable according to claim 2, wherein reflection is deliberately generated by adjusting the length of the auxiliary wire when creating the construction in which the main wire and auxiliary wire are combined in separated or integrated fashion or when winding the auxiliary wire around the periphery of the main wire in the longitudinal direction of this main wire, so that surge is suppressed by canceling a specific frequency component of the surge by the reflection thus generated.

8. The reflective surge suppressing cable according to claim 2, wherein, in the main wire and auxiliary wire, the conductor is covered with a conductive material or plating in order to further promote reduction of high-band noise and to increase resistance and/or inductance.

9. The reflective surge suppressing cable according to claim 3, wherein, in the main wire and auxiliary wire, the conductor is covered with a conductive material or plating in order to further promote reduction of high-band noise and to increase resistance and/or inductance.

10. The reflective surge suppressing cable according to claim 2, wherein, in the main wire and auxiliary wire, in order to promote reduction of high-band noise, an insulator of high permittivity and/or an insulator of high dielectric loss are/is employed as the insulator.

11. The reflective surge suppressing cable according to claim 3, wherein, in the main wire and auxiliary wire, in order to promote reduction of high-band noise, an insulator of high permittivity and/or an insulator of high dielectric loss are/is employed as the insulator.

12. A reflective surge suppressing cable according to claim 6, further provided with shielding on top of said combination.
